(19) United States
(12) Patent Application Publication
(10) Pub. No.: US 2020/0387438 A1
(43) Pub. Date: Dec. 10, 2020

(54) TRACKING HARDWARE EVENTS WITHIN A PROCESS ON AN INSTRUCTION-LEVEL SIMULATOR

(71) Applicant: HEWLETT PACKARD ENTERPRISE DEVELOPMENT LP, Houston, TX (US)

(72) Inventors: TODD AUSTIN CARRINGTON, Roseville, CA (US); Ryan D. Menhusen, Ft. Collins, CO (US); John L. Byrne, Pasadena, CA (US)

(21) Appl. No.: 16/436,732

(22) Filed: Jun. 10, 2019

(51) Int. Cl. G06F 11/34; G06F 17/50; G06F 11/30; G06F 12/10

(52) U.S. Cl. CPC G06F 11/3457; G06F 17/5009; G06F 12/10; G06F 11/3452; G06F 11/302

(57) ABSTRACT

Systems and methods are provided for accurately simulating a hardware computing system. Application programming interfaces (APIs) are called within process code, the process being executed in simulation of the hardware computing system to start, stop, pause, and/or end tracking of one or more hardware events correlated to data about which a user wishes to receive statistics. Defining APIs within the process code allows per-process and per-instruction level granularity in the statistics.

### DESCRIPTION OF RELATED ART

The advent of technology has led to an exponential growth in the computational power of computing systems. Use of multi-processor (e.g., multi computer processing unit or CPU) devices and multi-core processors (which include a number of cores or processor) in computing systems, has also contributed to the increase in computational power of computing systems. Each of the cores or processors may include an independent cache memory.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A illustrates an example of a hardware computing system that may be simulated in accordance with various embodiments.

FIG. 1B illustrates an example one-to-many core processing system architecture of one processor in the hardware computing system of FIG. 1A.

FIG. 2 illustrates an example simulation system configured in accordance with various embodiments.

FIG. 3 illustrates an example computing component capable of executing instructions for effectuating hardware event tracking in a simulated hardware computing system in accordance with various embodiments.

FIG. 4A illustrates an example hardware event tracking scenario that may be performed by the example computing component of FIG. 3.

FIG. 4B illustrates an example start API routine scenario that may be performed by the example computing component of FIG. 3.

FIG. 4C illustrates an example stop API routine scenario that may be performed by the example computing component of FIG. 3.

FIG. 5 illustrates an example computing component in which various embodiments described herein may be implemented.

The figures are not exhaustive and do not limit the present disclosure to the precise form disclosed.

### DETAILED DESCRIPTION

Processors or CPUs refer to electronic circuitry within a computer that carries out the instructions of a computer program by performing the basic arithmetic, logical, control and input/output (I/O) operations specified by the instructions. Processing performance of computers can be increased by using multi-core processors or CPUs, which essentially amounts to plugging two or more individual processors (called cores in this sense) into one integrated circuit. Ideally, a dual core processor would be nearly twice as powerful as a single core processor, although in practice, the actual performance gain may be smaller. Increasing the number of cores in a processor (i.e. dual-core, quad-core, etc.) increases the workload that can be handled in parallel. This means that the processor can now handle numerous asynchronous events, interrupts, etc. With multi-processor computers or systems, however, more than a single processor or CPU can be supported, e.g., two to eight or even many more CPUs, such as may be the case with petascale supercomputers and exascale supercomputing systems.

Generally, the memory of a computing system includes a main memory, such as a non-volatile memory (NVM), and a cache memory (or simply, cache). The main memory can be a physical device that is used to store application programs or data in the computing system. The cache stores frequently accessed data so that time need not be spent accessing the data from the main memory. Typically, data is transferred between the main memory and the cache in blocks of fixed size, referred to as cache lines. When a processor of the computing system has to read from or write to a location in the main memory, the processor reads from or writes to the cache if the data is already present in the cache, which is faster than reading from or writing to the main memory. Data that is written to the cache, is generally written back to the main memory.

In a multi-compute-engine system, each compute engine, such as a core or a processor, includes one or more caches, and generally, a cache is organized as a hierarchy of one or more cache levels. Users or customers who purchase large multi-core processing systems (also referred to as the aforementioned exascale systems, which can scale to enough nodes to execute, e.g., a billion-billion calculations per second), often conduct simulations of such proposed, multi-core processing systems to judge performance when they select vendors. However, simulating a complex memory-centric system at a high level of detail can be difficult because simulating the memory hierarchy of a multi-core processing system can greatly increase the time needed to conduct a simulation. Moreover, monitoring simulated hardware usage or performance of such complex memory-centric systems, especially in the context of cache simulations, is also made difficult due to complexities resulting from, e.g., sharing actual CPU resources to increase utilization, e.g., hyper-threading.

Accordingly, various embodiments provide a simulator capable of monitoring and tracking various simulated hardware events or related statistics (e.g., such as those related to memory operations described above) at a high level of detail. This can be accomplished without impacting the simulated system. As used herein, the term “hardware” can refer to any physical part or aspect of a system being simulated, including the effect or impact those physical parts or aspects may have on the system as a whole (e.g., an interrupt from a storage device will interrupt the CPU, which in turn will interrupt the operating system). An application programming interface (API) routine can be constructed from a series of “no operation” (NOP) instructions, for example, that do not change the state of the simulated hardware, and enables an individual process (rather than conventional performance information gathering) in the simulator to control the tracking of various simulated hardware events as they pertain to that individual process on an instruction-by-instruction basis. It should be understood that the ability of a simulation to capture information about how a process interacts with the system on every instruction it may execute differs from conventional, generally polled information or statistics gathering. Thus, in accordance with various embodiments, the simulator, through using the API routine combined with operating system-specific process tracking information, is able to perform event tracking only when a particular process is in context/execution and until instructed to end tracking. For example, in order to track a process and its threads as they move from running to idle states, a simulation in accordance with various embodiments may obtain information from a currently running process that the operating system places in CPU registers, and this combined with API call information, can track a process and its threads as it processes through the system. In this way, certain functions, such as interrupt handling and kernel scheduling can be avoided, allowing blocks of code of the software (i.e., simulated hardware) being tracked to be isolated. Additionally, algorithms can be adjusted/changed, and/or the number of events occurring between executions of the process of interest may be determined and compared.

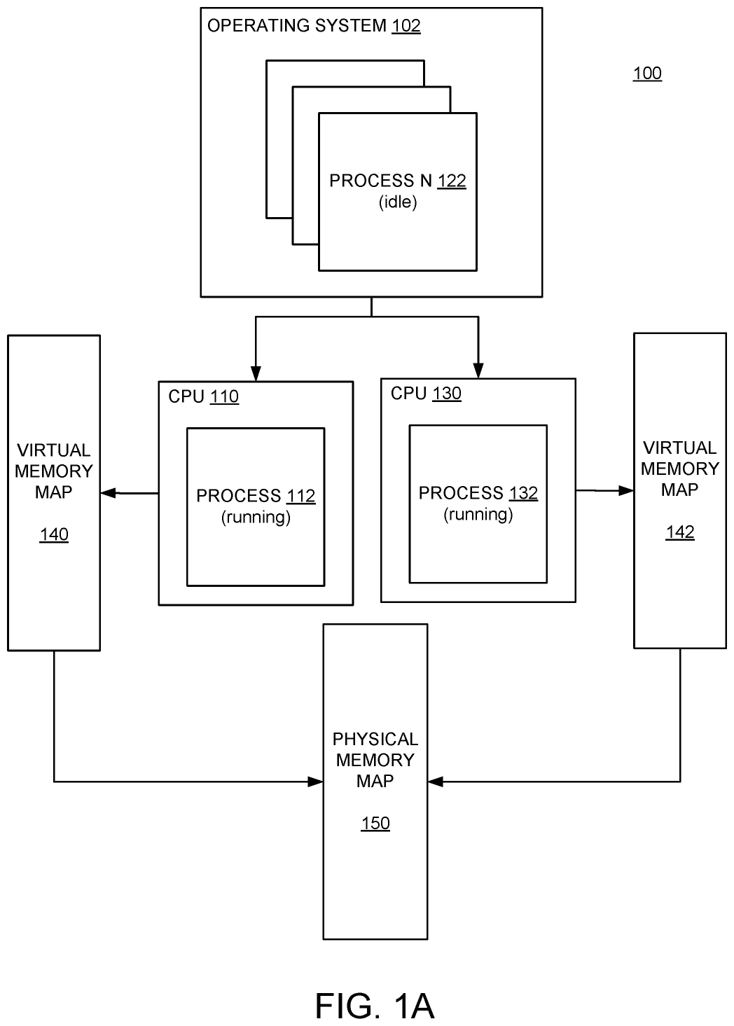

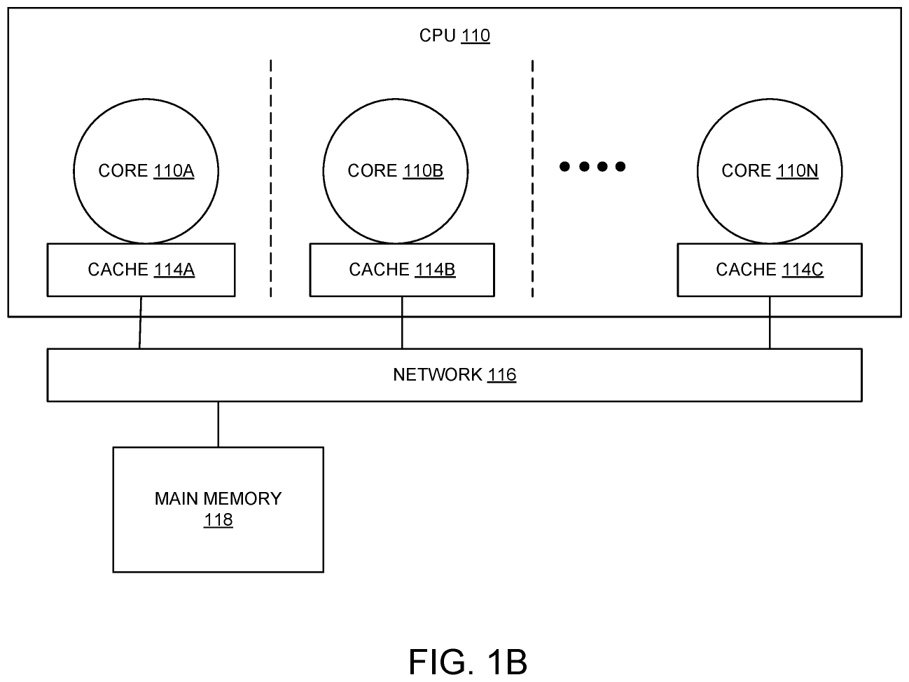

FIG. 1A illustrates an example of a hardware computing system 100 that can be simulated by a simulator configured in accordance with various embodiments, and from which, information of interest may be monitored and tracked. A system, such as hardware computing system 100, may comprise various elements or components, circuitry, software stored and executable thereon, etc. However, for simplicity and ease of explanation, only a few aspects are illustrated and described.

Hardware computing system 100 may include an operating system or OS 102 in which one or more processes containing zero or more threads may be running (or idle) on multiple CPUs (110 and 130). As described herein, a process may have the ability to create a thread, which in turn creates another “lightweight” process that shares the “parent” process's data, but that can be run independently on another processor at the same time as the parent process. It should be understood that an aspect of the various embodiments described herein distinguishing it from conventional systems is that a simulation/simulator in accordance with various embodiments can track on the thread level as well, for as many threads as the parent process creates). For example, a process N 122 (along with other processes) may be idle in operating system 102, while other processes, e.g., processes 112, 132 may be running on CPUs 110 and 130, respectively. FIG. 1A further illustrates a high-level flow for memory maps of each executing process involving virtual memory map 140 for CPU 110 and virtual memory map 142 for CPU 130, and physical memory map 150.

FIG. 1B illustrates an example architecture of CPU 110 of FIG. 1A. In one example, CPU 110 may be operable on a directory-based protocol to achieve cache coherence. CPU 110 may be, for example, a multi-processor system, one-to-many core system, or a multi-core processor system. Accordingly, CPU 110 may comprise multiple processors or cores, and in this example, may include multiple cores 110A, 110B, . . . 110N.

Each of the cores 110A, 110B, . . . 110N, may have one or more cache levels 114A, 114B . . . 114N associated with them, respectively. A network 116 (which may be a system bus) allows cores 110A, 110B, . . . 110N to communicate with each other as well as with a main memory 118 of CPU 110. Data of main memory 110 may be cached by any core of CPU 110, for example, any of cores 110A, 110B . . . 110N.

Referring back to FIG. 1A, CPUs 110, 130 each implement a virtual memory management system. For example, CPU 110 generates memory references by first forming a virtual address, representing the address within an entire address range by the architectural specifications of the computer or that portion of it allowed by operating system 102. The virtual address may then be translated to a physical address in physical memory map 150 constrained by the size of main memory 118. In some embodiments, translation is done with pages, so a virtual page address for a page in virtual memory map 140 is translated to a physical address for a page in physical memory map 150. A page table is maintained in memory to provide the translation between virtual address and physical address, and usually a translation buffer (not shown), is included in the CPU to hold the most recently used translations so a reference to a table in memory 118 need not be made to obtain the translation before a data reference can be made.

As alluded to above, there is a need for simulating hardware computing systems, and assessing performance by tracking various hardware events with a high level of detail, and collecting statistics. Collecting operational statistics can be useful to understanding the performance of software running on a system in simulation because instruction-level simulations should execute instructions and effect the underlying hardware in the same manner as a real system. Accordingly, various embodiments avoid hardware interrupts because such interrupts are generally not part of the tracked process' instruction flow. In this way, processing that happens upon an interrupt can be filtered out from the statistics that are gathered. Moreover, measuring performance and operating speed of a simulated hardware computing system can be skewed by other factors due to running in simulation. That is, there can be a need to simulate a system and collect statistics with a high-level of detail in order to tune software to run on hardware as fast as possible. Accordingly, embodiments avoid collecting statistics on any processes/processing that may occur while the process is running, but which are not directly related to the process itself (e.g. a network interrupt that happens while a process is running) is, as noted above, not relevant, and can therefore, be filtered out by a tracker (described in greater detail below).

It should be noted that gathering statistical information about a hardware computing system is generally accomplished through hardware polling, where at certain intervals, the hardware will interrupt to see if a program/application is running, and if so, capture relevant information. However, this method of gathering information does not achieve a per-instruction level of granularity. Additionally, information about hardware is generally limited by what the hardware has been pre-configured to report or share. In general, and unlike systems in which conventional polling is used, various embodiments are able to collect statistics on the effect a process's instructions may have on the simulated system for every instruction that is executed in the context of the “run” state.

It should be further understood that embodiments described herein are from the perspective of a hardware computing system component, such as a CPU. However, hardware event tracking in a simulation as disclosed herein need not be limited to the component level. Rather, hardware event tracking can be accomplished on end point devices, the network fabric, etc.

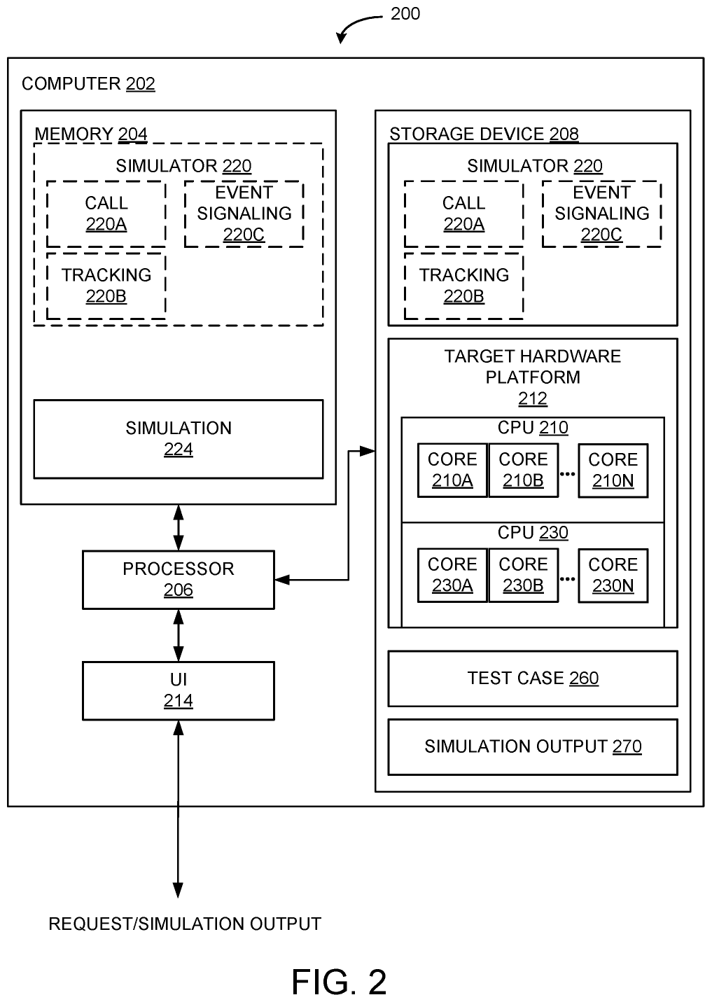

FIG. 2 illustrates an example simulation system 200 in which a simulator can be implemented and used to simulate a hardware computing system, and provide a hardware event tracking mechanism to glean information about a process in a operating system running on the simulated hardware computing system. That information may include, but is not limited to, tracking the number of instructions performed in a process, determining cache statistics, e.g., the number of cache misses that occurred during execution of a process, etc.

Simulation system 200 may include a computer 202, which in turn, may have a memory 204, a processor 206, a storage device 208, and a user interface 214. It should be understood that more or less components/elements may exist as part of simulation system 200 and computer 202 in accordance with other embodiments. For example, simulation system 200 may optionally include an interactive device (not shown) operatively connected to user interface 214. Such an interactive device may be, for example, a computer terminal used by a verification engineer to interact with computer 202. Otherwise, as illustrated, a user may interact with computer 202 directly vis-a-vis user interface 214. Storage device 208 may be, for example, a disk drive or other storage device that stores software and data of computer 202.

As illustrated, storage device 208 may have stored therein, a simulator 220, a target hardware platform 212 (i.e., the hardware computing system to be simulated), a test case 260, and some form of a simulation output 270 that can be produced or generated for a user. Simulator 220 may comprise one or more software-implemented algorithms or instructions for effectuating simulations on target hardware platform 212, as will be described below. In operation, a user, such as the aforementioned verification engineer, can enter a request, via user interface 214, to instruct processor 206 to load simulator 220 into computer memory 204, for execution therein. Simulator 220 is therefore indicated using dashed lines within computer memory 204, for purposes of illustration.

In the example illustrated in FIG. 2, target hardware platform 212 may have two CPUs 210 and 230, each with two or more cores 210A, 210B, . . . 210N, 230A, 230B, . . . 230N. More or less CPUs and/or cores may be simulated as part of target hardware platform 212 as a matter of design choice. In the illustrated example, storage device 208 is shown with one test case 260 according to which a simulation may be performed, although additional test cases may be included in storage device 208, also as a matter of design choice. Test case 260 may comprise instructions executed by processor 206 for simulating operations performed on/with target hardware platform 212. For example, test case 260 may involve a user attempting to run or execute various programs, applications, or other processes on target hardware platform 212. It should be understood that as used herein, the term process can refer to a set of executable instructions that uniquely run on an operating system. A process may have a code/text section, a heap section, and a data section, and a process may have its own set of resources for code execution, memory allocation, etc. It should be noted that in general, a process may have code, data, heap and stack sections. Threads share code and data of the parent, but have their own stack. The API routine can be called within the thread of a process to track as many threads as the user wants, yet only collect statistics related to that thread while running as opposed to the entire process. Applications, programs, software, and the like can be synonymous with the term process or two or more processes may make up an application, program, software, etc. It should also be understood that each process may have a unique identifier so that data can be written to memory without issue (e.g., without overwriting data of another process), and as noted above, individual processes can be tracked.

In operation, simulator 220 may create a simulation 224 for target hardware platform 212 in memory 204. Simulator 220 may load all or part of target hardware platform 212 into simulation 224. Simulator 220 may then simulate operation of target hardware platform 212 using, e.g., simulation data, event stimuli, and/or test instructions of test case 260 to produce simulation output 270. The simulation output 270 can be sent, displayed, or otherwise represented to a user via user interface 214.

Simulator 220 may include certain mechanisms to track hardware events, including, e.g., a call mechanism 220A, a tracking mechanism 220B, and an event signaling mechanism 220C. The call mechanism 220A may be an application programming interface (API) routine that can be embedded in process code to request tracking of a hardware event associated with or involved in a process while running. In this way, the process may call the API to start and end tracking of an object or target. As used herein, an object or target that is tracked can refer to some collection of data that has a close relationship. As described herein, an object or target may be an instruction count, a cache, or any other simulated hardware or software element/component about which information through tracking is desired. For example, if a user wishes to track the instruction count associated with a print process, the process code may call the API routine to start tracking instruction counts. It should be noted that instead of an embedded API routine, the API routine may be a pre-compiled binary code loaded into the process, or alternatively still, a wrapper.

Tracking mechanism 220B may be made up of an API routine (or a wrapper or pre-compiled binary code) embedded in the process that, when called, will determine the information necessary to track the process and take a snapshot of all relevant hardware related to an event, etc., and generate information indicative of this snapshot. The tracking mechanism 2006 may further comprise functionality that will automatically pause the process's event tracking as it is context-switched by the operating system. This automated tracking can be achieved by checking hardware registers when the API call is made that contain unique information about the active process context. Moreover, as interrupts occur, the process's tracking may be paused to prevent the tracking of events not directly related to the process's execution (e.g., network-related interrupts). Further still, the tracking mechanism 2206 may also comprise an API routine to stop the tracking of events, as well as an API routine to end the tracking of events, which can result in collected and/or calculated information being returned to the user.

In accordance with various embodiments, the aforementioned snapshot or state of the hardware/process may be compared to the state of the hardware/process captured in a future or subsequent snapshot(s), e.g., after a pause or stop track API call in the process code. This comparison or difference can be determined to determine what change(s) may have occurred between snapshots. For example, if tracking is started at the beginning of process execution and stopped when the process goes idle, and the user is interested in instruction counts associated with the process, the comparison of states can return the number of instructions performed while the process was running. It should be understood that the aforementioned API routines can be called as needed (in any order, any number of times, etc.) to obtain the desired information. Therefore, and again, a generic framework is provided that can compile data about hardware events as they occur in a simulated system at a granularity up to a per-instruction basis. As events occur, snapshots may be continually compared, for example, against the last snapshot, to obtain rolling hardware event tracking. The aforementioned pause and stop API routines that can be called by the process include returning, to a pre-allocated memory space within the process, the collected data/information, where that data/information is stored in pre-defined formats defined in the API routine(s) itself.

Event signaling mechanism 220C may be an API routine that is called to trigger events that can be tracked (e.g., tracked by tracking mechanism 2206) in order to obtain information regarding those events. That is, the API routine provides a user with the ability to request whatever information the user wishes to track (e.g., instruction count data or cache data, as noted above, as well as PCI data, interrupt data, etc.). As also noted above, tracking hardware events in accordance with various embodiments is performed on a per-process basis for greater granularity. This can be accomplished by uniquely identifying the process while it is running or being executed to create events in the simulation that are directly related to the data types that the user wishes to track. As a result, any number of processes being simulated may be concurrently tracking the same data types in the simulation. To provide additional granularity between a user-level process and the operating system's code, the privilege level of the event can be included in the user's results to provide an additional layer of granularity. While running, should any of the events the process is tracking occur, that event will fire allowing any processes tracking it to “snapshot” the simulated hardware computing system's/target hardware platform's state. It should be noted that API routines can be called, thereby triggering an event as noted above. However, in some embodiments, events can be automatically triggered as a process progresses from a running or execution state to a non-running or idle state. Thus, the operating system itself can trigger events.

In order to accomplish event signaling, an eventing architecture or design pattern may be used to effectuate the triggers, not only to create/generate snapshots of a current state of hardware, but allows associating the ability to create snapshots to a particular hardware event, e.g., a process being put into an idle state. Accordingly, the eventing architecture can be a template solution or software design pattern that can be transformed into code in which an object/subject may maintain a list of its dependents/observers, and notifies them of any state changes. In this context, the eventing architecture may notify trackable objects or targets of need to act in some way. For example, if the trackable object is an interrupt, the eventing architecture can tie into the interrupt architecture and associate an interrupt event with tracking information so that when the interrupt fires, the appropriate tracking of the interrupts can be performed vis-a-vis the API routines. Here, the interrupt is the event subject, the tracker of interrupts are the event observers. For example, if a user simply wishes to know how many interrupts occurred in the simulated system while a process was running, a software event in the simulator would be enabled for all interrupts, and a tracker would observe those interrupt events, incrementing a counter for each interrupt event it observed.

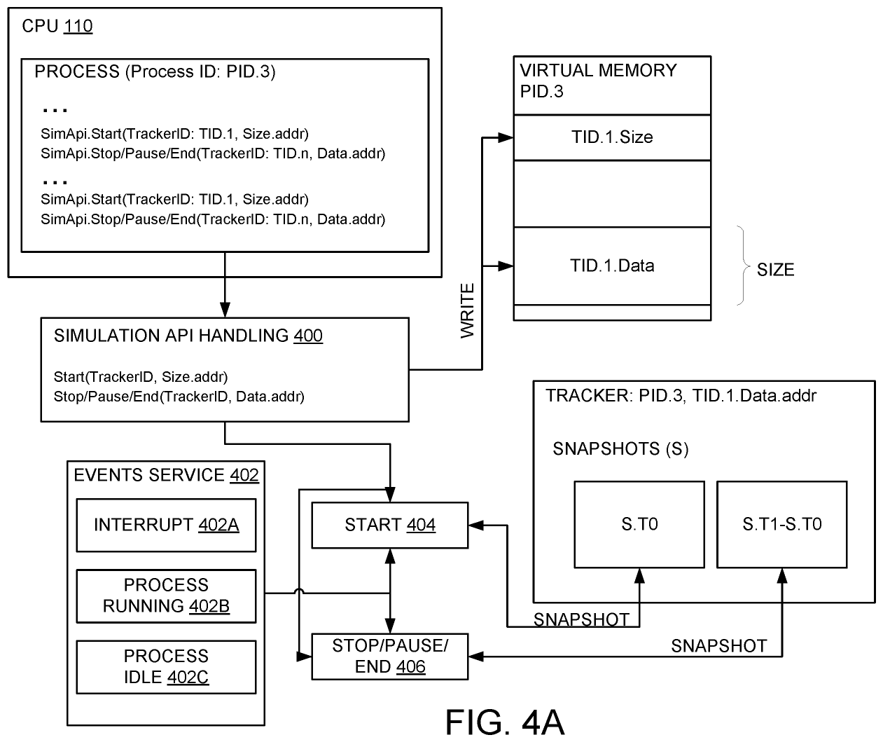

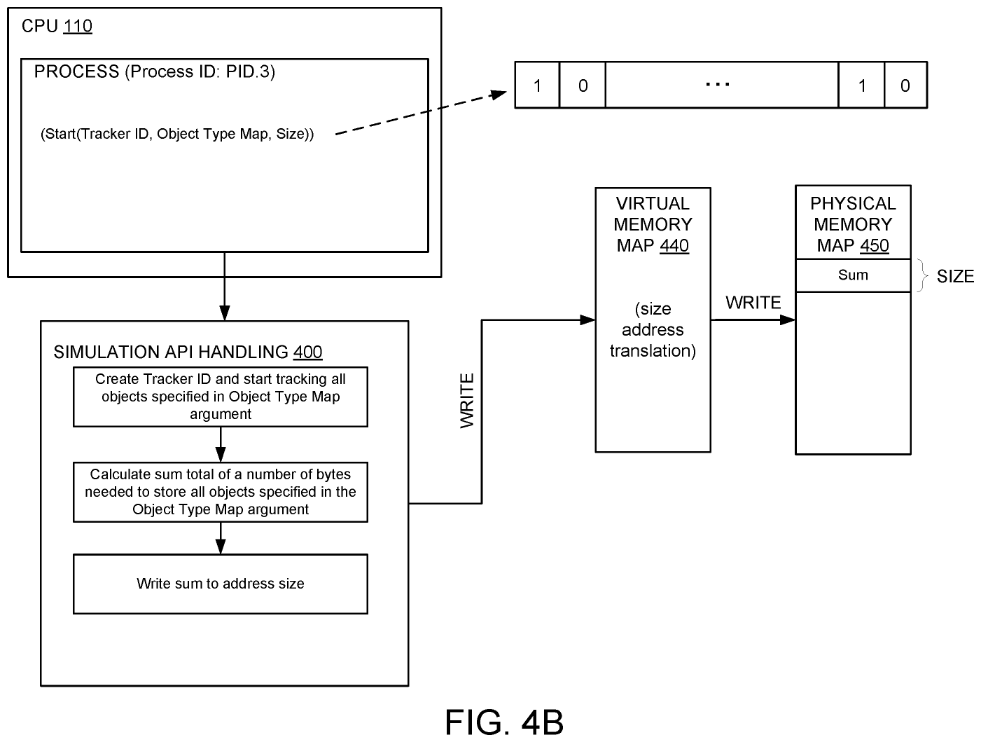

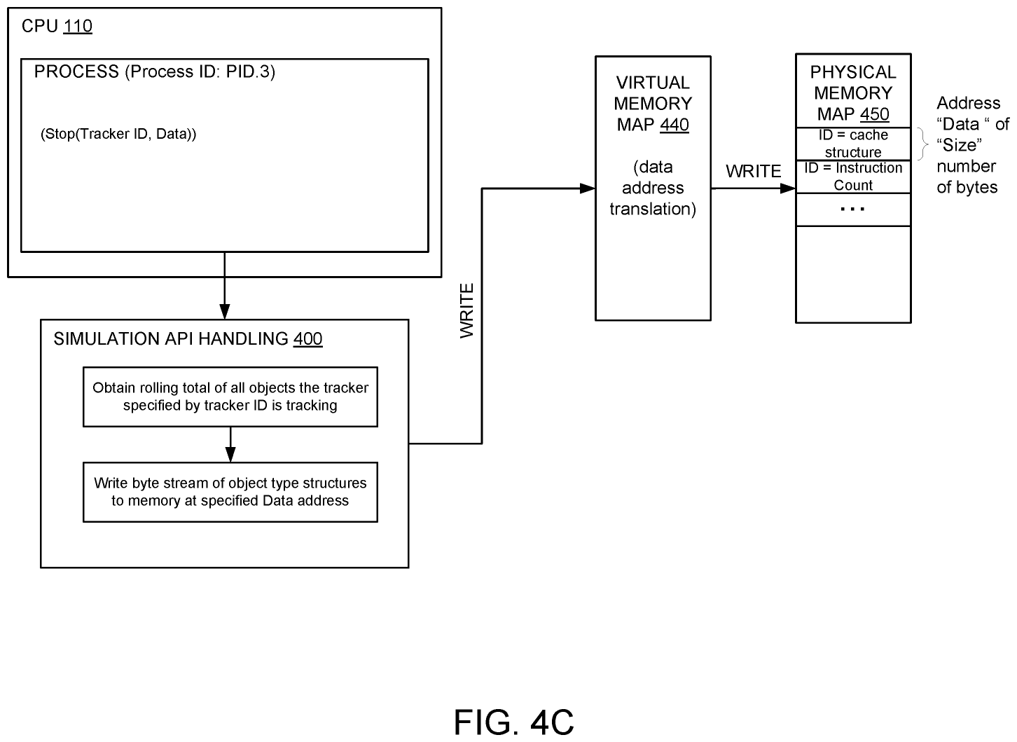

It should be understood that the API routines may trigger “recording” (e.g., keeping a rolling total) of trackable information, such as interrupts, instruction count, cache information, etc. For example, and referring to FIG. 4 (discussed below), “PROCESS” and “API HANDLING 400” can make up an API or API route (also illustrated as CALL 220A in FIG. 2), and as shown, the API routine may handle all of the manual start, pause, stop and end aspects of tracking done in the process's code. The aforementioned eventing architecture can refer to, e.g., generic subject (interrupt, process context-switched out, etc.) and observers (trackable objects, such as cache state, number of instructions, etc.), which is depicted as event signaling 220C in FIG. 2. Eventing can be used to notify the tracked object (observer) to start or pause tracking as the process is switched out (from running to idle). It should be noted that the tracking (220B of FIG. 2) can refer to any sort of tracking, e.g. cache tracking, instruction tracking, etc., provided a snapshot of its current state can be captured, and the difference relative to a future state can be calculated so that a running total can be determined, if need be.

As alluded to above, API routines can be constructed from a series of NOP instructions. That is, in actual (not simulated) hardware, NOP instructions are instructions that do not change the state of the CPU or system, except to, for example, increment a program counter in the CPU. However, in simulation, NOP instructions can indicate that a process wishes to call an API into the simulation. Thus, when compiled in hardware, the NOP instructions do not necessarily result in any action, but in simulation, are seen as an instruction, e.g., the simulation is aware that the user wishes to take some sort of action, e.g., start tracking the number of instructions the process executes.

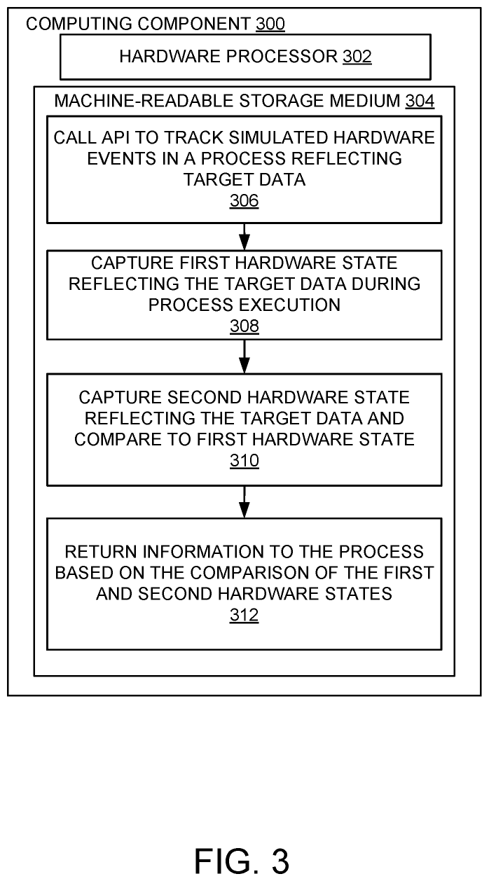

FIG. 3 is a block diagram of an example computing component or device 300 for generating and using a flat cache simulation with one embodiment. Computing component 300 may be, for example, a server computer, a controller, or any other similar computing component capable of processing data, such as a modeled CPU core or cache hierarchy driver (as contemplated above). In the example implementation of FIG. 3, computing component 300 includes a hardware processor 302, and machine-readable storage medium 304. In some embodiments, computing component 300 may be an embodiment of a processor, e.g., processor 206 of simulation system 200 of FIG. 2, for example.

Hardware processor 302 may be one or more central processing units (CPUs), semiconductor-based microprocessors, and/or other hardware devices suitable for retrieval and execution of instructions stored in machine-readable storage medium, 304. Hardware processor 302 may fetch, decode, and execute instructions, such as instructions 306-312, to control processes or operations for performing a simulation in accordance with one embodiment. As an alternative or in addition to retrieving and executing instructions, hardware processor 302 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 304, may be any electronic, magnetic, optical, or other physical storage device that contains or stores executable instructions. Thus, machine-readable storage medium 304 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 304 may be a non-transitory storage medium, where the term “non-transitory” does not encompass transitory propagating signals. As described in detail below, machine-readable storage medium 304 may be encoded with executable instructions, for example, instructions 306-312. Machine-readable storage medium 304 may be an embodiment of storage device 208.

Hardware processor 302 may execute instruction 306 to call an API to track simulated hardware events in a process reflecting target data. As noted above, various API routines, constructed of NOP instructions may be embedded (or pre-compiled binary code or a wrapper subroutine in the process code) in process code. It should be noted that when an API routine is first called, certain parameters are passed into the simulation (e.g., simulation 224 of FIG. 2) so information/data can be returned to the process. Accordingly, the API routine can be written or programmed such that a memory location within the process's address space is passed in to allow the tracked information to be passed back to the process. As will be described in greater detail below, an API routine can be called to stop tracking (e.g., stop tracking the number of instructions processed), at which point the gathered information is written into a memory location of the process's memory space, such as a buffer that was specified per the above-described passing of parameters. It should be understood that the memory space is actual memory local to the process. API routine calls made in the process and which return data back into the process can send/receive data directly to/from main memory via a direct memory access (DMA) method.

As described above, a hardware computing system, such as a hardware computing system 100 of FIG. 1, employs virtual memory vis-a-vis virtual memory maps that through translation can refer to physical memory (translation of virtual memory addresses to real memory addresses in physical memory). Because the hardware computing system 100 is being simulated as a target hardware platform (e.g., target hardware platform 212 of FIG. 2), the simulation has access to this translation process, and as a result can be made aware of where physical memory is located. In turn, the simulated process can write back into its memory space. It should be understood that operating system 102 can update translations based on the process at issue to maintain the proper relationship between virtual and real memory addresses.

Referring back to FIG. 3, hardware processor 302 may execute instruction 308 to capture a first hardware state reflecting the target data during process execution. When an API routine is called to start tracking a hardware event, such as the processing of an instruction, or a cache operation, a snapshot of the current state of hardware related to the hardware event may be captured, e.g., the number of instructions processed in relation to the process at issue. Hardware processor 302 may further execute instruction 308 to capture a second hardware state reflecting the target data, which may then be compared to the first hardware state. That is, an API routine may be called to stop tracking the hardware event to capture the now-current state of hardware, in this example, the number of instructions processed thus far since the first snapshot of the hardware was captured.

Hardware processor 302 may execute instruction 312 to return information to the process based on the comparison of the first and second hardware states. As described above, because certain parameters are passed into the simulation by the API routine initially called to start tracking, the captured/calculated information can be returned back to the process's own memory space.

FIG. 4A illustrates an example scenario involving hardware event tracking of a simulated hardware computing system, in particular, CPU 110 of hardware computing system 100 of FIG. 1. As illustrated in FIG. 4A, CPU 110 may have one or more processes running thereon in an operating system, e.g., operating system 102. As discussed above, calls to API routines may be embedded in the process code to perform various actions, e.g., start tracking, stop tracking, pause tracking, and end tracking. As also discussed above, the API routines may include certain parameters that allow collected information or data to be returned to the process's memory. Moreover, as illustrated in FIG. 4, the process is given a unique identifier (PID.3) so that data can be written to memory without issue (e.g., without overwriting data of another process), and so that individual processes can be tracked accordingly. It should be noted that in some embodiments, a process identifier is not needed in the call, as this can be gleaned from a CPU's hardware registers to create a “process identifier” used to track the process as it is swapped (from running to/from idle). Again, various embodiments are directed, in part, to providing granularity when tracking simulated hardware events, e.g., on a per-process and per-instruction level.

FIG. 4A illustrates that API routine calls to start tracking (“SimApi.Start(TrackerID.TID.1.Size.addr), where a tracker identifier, size address are specified. The tracker identifier, TID.1, can be a unique identifier used to associate a collection of target data (e.g., an instruction count) within a process. For example, a program to print “hello world” and “goodbye world” could be a process 0, and tracked as follows:

Api(start tracking, 0)

Print(“hello world”);

Api(start tracking, 1)

Print(“goodbye world”)

Api(stop tracking, 1)

Api(stop tracking, 0)

The above example uses two tracker identifiers (0 and 1) to create two unique recordings of the simulated system's state as code in process 0 is executed. Here, the tracker for TID.0 would record the system state from when “start tracking 0” occurs until “stop tracking 0” occurs. Thus, for instruction count, it would include all the instructions in the “hello world” call and the “goodbye world” call. However, TID.1 would be a separate tracking session (but also part of process 0) that would only include the instruction count for the call to “goodbye world.”

It should be noted that the tracker identifier can refer to any unique set of hardware statistics a user may wish to monitor as discussed above. The size address can be used to indicate an address in the process's memory space where the simulator can write the size (i.e., number of bytes) necessary to store the collected or tracked data. Another API routine can be called to stop, pause, and/or end tracking of the tracked object (identified as TID.n and a data address in virtual memory where the tracked data can be returned for storage.

It should be understood that the “/” indicates that after a “start” is made for a unique tracker identifier, the next API call for that tracker identifier can be either pause, stop or end. If the subsequent call is a stop API call, the simulator will return all the information (totaling “size” bytes from the start call) to the process's address space at address “Data” and reset all the trackable objects (i.e., the rolling total is erased). If a subsequent API call is a pause, the same information from the stop API call will be returned, but the rolling total will not be erased. It should be further noted that following a pause or a stop, a subsequent start call may be made to, in the pause case, continue recording events and in the stop case, restart recoding events with a clear state. This start-to-pause-to-start or start-to-end-to-start “iteration” may be made as many times as desired, and at each end or pause, information about the events that occurred can be returned. In the end case, where the tracker identifier is freed, tracking completely finish, and no more calls may be made with that tracker identifier. If the subsequent API routine call is an end API routine call, the same data obtained pursuant to the stop API routine call can be returned, and the tracker identifier can be freed ending the tracking session associated with the tracker identifier. Again, data can be returned to the process's local memory by virtue of translations between virtual and physical memory addresses vis-a-vis virtual and physical memory maps, e.g., virtual memory map 140 and physical memory map 150, and stored internally the state as well as return it to the process. It should be noted that hardware states can be saved to the simulation as well in addition to returning to the process so that on subsequent “starts,” a previous total can be added to, so another pause returns the sum of the first start-to-pause data, e.g., instruction count, as well as the second start-to-pause data.

At 400, when the API routine that was called is actually executing in simulation, the API routine called to start track may initiate tracking at 404. Tracking, as noted above, may comprise taking a snapshot, i.e., capturing a current state of the hardware at that point in time. This can result in a snapshot at time (S.T0), time 0 being the time tracking started. Handling of an API in simulation may further include a pause at 406, i.e., taking a (later) current snapshot of hardware's state (S.T1)(identified by the Tracker ID), comparing it with the previously captured state (S.T0), and storing the resulting snapshot and the current difference (S.T0-S.T1-S.T0). Handling of an API in simulation may also involve stopping tracking at 406, i.e., resulting in data being returned to the user, and resetting any data calculations for the tracker. In the context of counting instructions in the process, calling an API stop routine at 406 may retrieve that stored data from memory, output it to the user by way of a user interface (e.g., UI 214 of FIG. 2), and resetting the instruction count. Calling an end API routine at 406 may involve returning the collected/calculated data to the user (similar to the API stop routine), but further, deleting the tracker.

When returning data to the user, the data should be formatted to be understood by the user. Accordingly, as part of the API, the data format can be defined. For example, returned data regarding cache statistics will be different from returned data regarding instruction count. Thus, as part of an API start routine, the API indicates to the simulation, what information is being tracked. With the format defined in the API, on receiving an API pause or stop call, for example, the process will include a pointer to memory where it can write collected data, and then overlay structures/predefined formats in that memory to make sense of the stored data. The formats may provide context for the data over which it is overlaid.

It should be understood that data can be returned as a sequential stream of bytes to the process's memory address space at the memory address provided in the stop, pause and end API routine calls. The number of bytes in the stream is equal to the size returned to the process in the start API routine call. An example, basic structure with an identifier/ID field and a VERSION field may then be overlaid on the bytes at an offset of zero, for example, to determine what data is in the structure (e.g., ID 1 can mean Cache Data, ID 2 can be instruction count, and so on). Once the data type (pursuant to the specified ID) is determined, the full structure for that type can be overlaid (e.g., ID 1 refers to cache data, so the cache structure is overlaid with a zero offset so that the data may be accessed). The byte stream may include one or more contiguous structures totaling “size” (from the start API routine call) bytes, and containing structures representing the information the process is interested in, based on the objects it requested in the start API routine call. For example, a start API routine call with “start(tid 1, objs (=cache, instructions), size @ addr 0x12345)” would create a tracking session with TID of 1, and would track the cache and the instructions associated therewith. The size of the cache structure in addition to the size of the instruction structure are written back to the specified memory address, e.g., 0x12345. On subsequent pause, stop and/or end API routine calls, the “size” byes consisting of the cache structure and the instruction structure are written back.

Also illustrated in FIG. 4 are events services 402. As noted above, events trigger the same/similar behavior, but events may occur outside the process's view, e.g., network interrupts, that may prompt pausing of tracking to avoid tracking unrelated data. Additionally, as noted above, events such as the process being moved by the operating system from a running state to an idle state may prompt tracking to start and stop, respectively. Again, the ability of various embodiments to provide a high level of granularity with the tracked statistics include providing process-specific data collection. Thus, tracking may be paused when the process goes idle, e.g., in the context of tracking instruction count associated with a process, the relevant instructions are only those are occur/are processed while the process is running. The result may be an accumulation of statistics in the trackers collected only when the process is in the running state. This information may then be written back to the process's memory by the API routine. It should be noted that the aforementioned API routines (start, stop, pause, end) take into account the desire to run multiple processes on a resource, e.g., CPU, without hogging CPU resources.

It should be understood that events as described herein, can also refer to “software events” used to trigger, e.g., a pause in trackable objects/targets, and the start of trackable objects/targets. These types of events can be automated and performed in reaction to “hardware events” (different from the event architecture) that cause a process to be context-switched out. For example, an interrupt is a HW event that triggers a “software event” in the event architecture that then notifies all the observers. This informs the trackable objects (observers in the event architecture) to stop tracking information because the process is no longer running (e.g., the same is achieved as if a “pause” API call was made in the process's code). A later hardware event, like the interrupt completing, notifies the observers (an event in the event architecture) to “start” tracking again since the process is context-switched back in (i.e., returns to a running state). Other hardware events, like interrupts can be made into trackable objects and counted as also described herein. indeed “HW events” like interrupts could in fact also be made into trackable objects and counted. Indeed, any and all simulations that may be performed in accordance with various embodiments can generate statistics about the system being simulated, any of which may be tracked as described herein.

In certain instances, a summation is performed in addition to calculating a difference between previous and future current hardware states. For example, if a user wishes track instructions in a process, and the process involves a loop (or the user wishes to obtain statistical data regarding multiple executions of the process, the lifetime of the process, etc.), an API routine that involves summing instruction counts may be used to get data reflecting a running total.

It should be understood that in some embodiments, an API routine may return all trackable information to a user, whereas in some embodiments, an API routine may include or involve another argument that could selectively enable the tracking of various information. For example, FIG. 4B describes on embodiment involving a start API routine, where a start API routine can include tracker identifier, object type map, and size parameters/arguments. Again, the tracker identifier is a unique tracking session identifier that can be associated with all tracked information of a particular object type. An Object Type Map argument can be a bitmap indicating what event/hardware component to track, e.g., interrupts, cache, etc. A Size argument can specify a calculated amount of memory needed in a process's memory space to store gathered information or data regarding the object to be tracked (pursuant to subsequent pause, stop, or end API routine calls).

The start API call can transition to the simulation's API handling. Simulation API handling 400, in this example, may include performance of the following operations. It should be understood that these operations may be instructions stored in a machine-readable storage medium and performed by a hardware processor (similar to the instructions illustrated in FIG. 3 and described above). The operations may include creating a tracker identifier, and starting tracking of all objects specified in/by the Object Type Map argument in the process code. The operations may also include calculating a sum total of a number of bytes needed to store all objects specified in the Object Type Map argument. Further still, the operations may include writing the sum to an address size.

Also illustrated in FIG. 4B is a virtual memory map 440, which may be an embodiment of virtual memory map 140 of FIG. 1 to which data is written (ultimately written to physical memory), and a physical memory map 450, which may be an embodiment of physical memory map 150 of FIG. 1. At the virtual memory map 440, the size address may be translated, and the sum data may then be written to physical memory corresponding to an address set forth in physical memory map 450.

Referring now to FIG. 4C, an example stop API routine call scenario is illustrated and described. The start API call can transition to the simulation's API handling. Simulation API handling 400, in this example, may include performance of the following operations. It should be understood that these operations may be instructions stored in a machine-readable storage medium and performed by a hardware processor (similar to the instructions illustrated in FIG. 3 and described above). The operations may include obtaining a rolling total of all objects the tracker (specified by the tracker identifier) is tracking. The operations may further include writing a byte stream of object type structures to memory at the specified Data address. At virtual memory map 440, the data address is translated, and at the physical memory map 450, the actual data is written to the specified address. For example, an address may be specified to cache data, and another for instruction count data. It should be noted that the size specified in the Data argument should be equal to or greater than the Size argument specified in the start API route call.

Instruction-level simulations and the like (as described herein) can be useful for tracking process-level information, because a simulation is generally limited in the data it may collect based on the detail of the simulation. It also provides an opportunity to collect data at each instruction's boundary and provides full visibility of any corresponding hardware/hardware elements and hardware events (e.g., interrupts and PCI transactions as they flow through the simulation). Additionally, aside from how a process is tracked, the interface and underlying mechanisms described herein for tracking hardware events can remain the same regardless of the underlying hardware's specific implementation. The API routines can be configured to be flexible enough to allow a process to track the same events in multiple segments of the program. Allowing the same event to be tracked multiple times enables a process to track events within large or increasingly small code segments, in parallel. Because the API calls are made from within executing software, it provides the simulation the opportunity to glean (from hardware) unique information about the process needed to track it without the aid of special tools. Again, all that is needed to call an API routine.

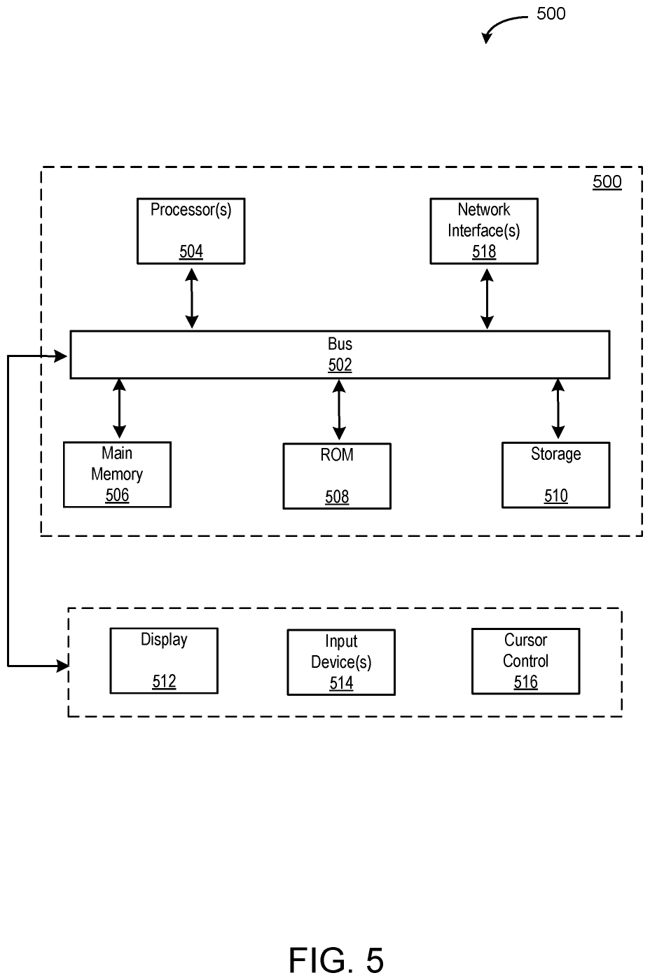

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for tracking hardware events in a simulated computing system, comprising:
calling an application programming interface (API) routine to track simulated hardware events in a process reflecting target data;
capturing a first hardware sate reflecting the target data during process execution;
capturing a second hardware state reflecting the target data and comparing to the first hardware state; and
returning information to the process based on the comparison of the first and second hardware states.

2. The method of claim 1, wherein the API routine comprises one of a start API routine, a stop API routine, a pause API routine, or an end API routine.

3. The method of claim 2, wherein the start API routine comprises instructions to capture the first hardware state.

4. The method of claim 2, wherein the pause API routine comprises instructions to capture the second hardware state and perform the comparison with the first hardware state.

5. The method of claim 4, wherein the pause API routine further comprises instructions to calculate a difference between the first and second hardware states, store the second hardware state in the process's memory along with a value reflecting the calculated difference, and at least one of store, to a simulation performing the simulated hardware events, the second hardware state, add the calculated difference to a rolling total reflecting hardware state up to a time commensurate with capturing of the second hardware state to create an updated hardware state, updating the first hardware state to become the send hardware state, and store, in the process's memory, an updated hardware state comprising the .

6. The method of claim 5, wherein the stop API routine comprises instructions to return the value to a user requesting the target data, and reset previous calculated performed regarding the target data.

7. The method of claim 5, wherein the end API routine comprises instructions to return the value to a user requesting the target data, and delete a tracking instance configured for the tracking of the simulated hardware events set forth in the API routine.

8. The method of claim 1, wherein the API routine is configured in code defining the process.

9. The method of claim 1, wherein the API routine is configured as a wrapper subroutine in the code defining the process.

10. The method of claim 1, wherein the API routine comprises pre-compiled binary code executing in the simulated computing system.

11. The method of claim 1, wherein the API routine is called pursuant to a triggering hardware event occurring in the simulated computing system.

12. The method of claim 11, wherein the triggering hardware event comprises an event unrelated to the target data.

13. The method of claim 1, wherein the API routine specifies a tracker identifier specific to the target data.

14. The method of claim 1, wherein the API routine specifies a type of data characterizing the target data and a predefined format for the target data.

15. The method of claim 14, further comprising storing the target data in accordance with the predefined format.

16. The method of claim 15, wherein the target data is stored in memory local to the process.

17. The method of claim 16, wherein the API routine specifies a virtual memory address for storing the target data.

18. The method of claim 17, further comprising performing a translation for mapping the virtual memory address to a physical memory address corresponding to the memory local to the process.

19. A simulation system, comprising:
a processor; and
a memory including a simulator comprising instructions causing the processor to execute a simulation of a hardware computing system, the simulation of hardware computing system, comprising:
simulating a process executing on the hardware computing system involving one or more hardware events;
tracking the one or more hardware events using one or more application programming interface (API) routines to capture one or more states of the hardware computing system associated with the one or more hardware events;
storing statistical data regarding the one or more tracked hardware events in memory local to the simulated process; and
presenting the stored statistical data or information derived from the stored statistical data to a user of the simulation system.

20. The simulation system of claim 19, wherein the one or more API routines are called as part of code defining the process or automatically called upon being triggered by the one or more hardware events.
